(19) United States
(12) Patent Application Publication
(10) Pub. No.: US 2013/0071584 A1
(43) Pub. Date: Mar. 21, 2013

(54) Skins Of Flexible Intelligence

(71) Applicant: Jonathan Arnold Bell, Long Beach, CA (US)

(72) Inventor: Jonathan Arnold Bell, Long Beach, CA (US)

(21) Appl. No.: 13/620,689

(22) Filed: Sep. 14, 2012

Related U.S. Application Data
(60) Provisional application No. 61/535,765, filed on Sep. 16, 2011.

(51) Int. Cl. B32B 3/30; B32B 3/24; B32B 3/06; B32B 1/06

(52) U.S. Cl. 428/34.1; 428/156; 428/131; 428/99

(57) ABSTRACT

This document describes the design of an articulated artificial skin that may be used to cover any three dimensional surface that changes morphology with time. In one embodiment the skin is made from individual four sided pyramids arranged to bend about their edges. Each pyramid may contain a solid, liquid, gas, or plasma, or any relevant technology such as solar panels and rechargeable batteries. Each pyramid may be connected to neighboring pyramids via tubes, pipes, or electrical wires to allow the flow of fluids and/or electricity. Multi layers of the artificial skin may be used to provide features such as pressure garments, cooling garments, thermal barriers, and armor shielding suitable for use in extreme environments.

### CROSS-REFERENCE TO RELATED APPLICATION

This application claims priority to U.S. Provisional Patent Application Ser. No. 61/535,765 to Jonathan Arnold Bell Entitled “Skins of Flexible Intelligence”.

### BACKGROUND OF THE INVENTION

Previous inventions relating to skins of flexible intelligence, or articulated artificial skin, and protective suits have used a variety of technologies to provide features that can enhance the performance of the wearer inside. Suits used for the exploration of space are particularly complex constructions providing the astronaut with pressurized internal suits that provide oxygen, remove carbon dioxide, cool the body temperature and protect from micro-meteoroid impact while still allowing for limited motion of the suit and the wearer. As a result of the high performance required, the limited sales market, and the hand made nature of manufacture, these garments can cost millions of dollars each. U.S. Pat. No. 3,345,641 by Jennings (1967) shown in FIG. 1(a) shows a high altitude suit design that supplies breathing oxygen, removes carbon dioxide, and cools the wearer by passing temperature controlled water through small tubes placed close to the skin to wick heat away. U.S. Pat. No. 3,428,960 by Schueller (1969) shown in FIG. 1(b) shows an example of a multi-layer structure of pressure suit design where each layer may provide different functions. As an example one internal layer may act as an air tight seal over the body of the wearer that expands when the pressure inside the layer is greater than the pressure of the external environment. A second layer may act as a restraint on the air-tight layer allowing it to expand no further than the limits of the restraint layer. While this design allows an astronaut to function in the vacuum of space without undue expansion of the human skin and internal organs, it also restricts the range of motion that the astronaut may perform. It can also cause bruising of the hands and feet because of the additional work required to bend and flex these regions within a pressurized balloon. More recent innovations in the design of wearable technologies and articulated artificial skin are outlined briefly as follows. U.S. Pat. No. 5,515,541 by Sacks & Jones (1996) shown in FIG. 1(c) introduces a multi-layer style of armor resistance that maintains impact protection but improves the ability of the armor to flex and bend therefore increases the range of motion for a wearer. U.S. Pat. No. 7,805,767 B2 by McElroy et al (2010) shown in FIG. 1(d) illustrates a method for incorporating electronic circuits between layers of armor plates that may provide for increased functionality and an improved form factor. U.S. Pat. No. 6,004,662 by Buckley (2010) shown in FIG. 1(e) illustrates a method for incorporating a phase change material between layers of a suit that may provide for increased functionality such as thermal cooling where heat is wicked from the body into the phase change material. Some phase change materials may also harden on impact to provide a form of instant armor protection.

Spacesuit design has not fundamentally changed since the Gemini and Apollo missions of the 1960's and there appears to be many areas where improvements can be made. For example, to ease the range of motion in a pressurized suit, the pressure difference between the inside of a current suit and the external environment may be set at close to eight pounds per square inch instead of sea-level pressure of fifteen pounds per square inch. This requires an astronaut to pre-breathe pure oxygen for a period of hours to remove nitrogen from their blood stream that may otherwise bubble out of the veins and arteries causing the ‘bends’. An innovation that has the internal pressure of the suit set at sea level pressure of fifteen pounds per square inch and allows for an increased range of motion would prevent the need for pre-breathing oxygen. Current spacesuits do not indicate where the suit may have been punctured and where subsequent pressure loss occurs thus endangering the astronaut. Weight distribution is imbalanced by the bulk of the Primary Life Support System (PLSS) worn on the astronauts back and caused nearly all moon-landing astronauts to fall over repeatedly. Protection from lunar regolith dust remains problematic and these micro-particles can readily create holes and tears in the outer space suit layers. Innovation in the design and manufacture of protective suits, skins of flexible intelligence (SOFI), and articulated artificial skins can be generally applied to many other occupations such as fire fighting, hazardous materials clean up, military personnel, sports athletes, and medical treatments. They may also be used to protect objects such as space satellites and a range of different vehicles and structures.

### OBJECTS OF THE INVENTION

One object of the present invention is to provide a design that allows for a flexible, bendable, articulated artificial skin made of discrete individual parts that conform over a three-dimensional surface that may adapt to changes in shape that occur as a result of physical motion.

A further object of the invention is to show that a flexible, bendable, articulated artificial skin may incorporate different technologies within its individual parts to add different functionalities to the skin.

A further object of the invention is to show that multiple flexible, bendable, articulated artificial skins may be layered on top of each other to provide additional functionalities.

A further object of the invention is to show that a flexible, bendable, articulated artificial skin may incorporate zippered openings and closings to allow a pre-formed skin to be more readily donned and doffed.

A further object of the invention is to show methods of design, construction, and manufacture of a flexible, bendable, articulated artificial skin.

### BRIEF DESCRIPTION OF THE DRAWINGS

FIGS. 1(a), 1(b), 1(c), 1(d), and 1(e) show examples of prior art related to the invention of skins of flexible intelligence.

FIGS. 2(a), 2(b), 2(c), and 2(d) illustrate various methods for constructing flat surfaces that may bend around a preferred axis.

FIGS. 3(a), 3(b), 3(c), 3(d), 3(e), 3(f), 3(g), 3(h), and 3(i) illustrate various methods for arranging three-dimensional pyramid shapes across a flat surface so that the pyramids may bend around a preferred axis.

FIGS. 4(a), 4(b), 4(c), and 4(d) show examples of interconnected three-dimensional pyramid shapes bending around different axis.

FIGS. 5(a), 5(b), and 5(c) illustrate a method for arranging three-dimensional pyramid shapes using pyramids of different size.

FIGS. 6(a), 6(b), 6(c), 6(d), and 6(e) illustrate various methods for arranging multiple layers of three-dimensional pyramid shapes.

FIGS. 7(a) and 7(b) illustrate a method for multiple layers of three-dimensional pyramid shapes to bend together as a curved surface.

FIGS. 8(a), 8(b), 8(c), 8(d), 8(e), and 8(f) illustrate various methods for interconnecting neighboring three-dimensional pyramid shapes using electrical wiring, artificial muscle, and fluid connecting pipes.

FIGS. 9(a), 9(b), 9(c), 9(d), 9(e), 9(f), 9(h), 9(i), 9(j), 9(k), 9(1), 9(m), and 9(n) illustrate various methods for providing pressurized gas and fluid containers inside three-dimensional pyramid shapes.

FIGS. 10(a) and 10(b) illustrate a method for arranging multiple layers of three-dimensional pyramid shapes that form frusta, where each frusta includes a plateau top surfaces.

FIGS. 11(a) and 11(b) illustrate a method for incorporation of a zipper mechanism into a multi-pyramid surface.

FIGS. 12(a) and 12(b) illustrate a method for incorporating zipper mechanisms and gas sealed areas into a wearable suit.

FIGS. 13(a), 13(b), 13(c), 13(d), and 13(e) show examples of technologies available to measure, re-construct, and fabricate copies of three-dimensional geometrical surfaces.

FIGS. 14(a), 14(b), 14(c), 14(d), 14(e), 14(f), 14(g), and 14(h) illustrate an initial method for construction of an array of three-dimensional pyramid structures.

FIGS. 15(a), 15(b), and 15(c) illustrate a further method for construction of an array of three-dimensional pyramid structures.

FIGS. 16(a), 16(b), and 16(c) illustrate a further method for construction of an array of three-dimensional pyramid structures.

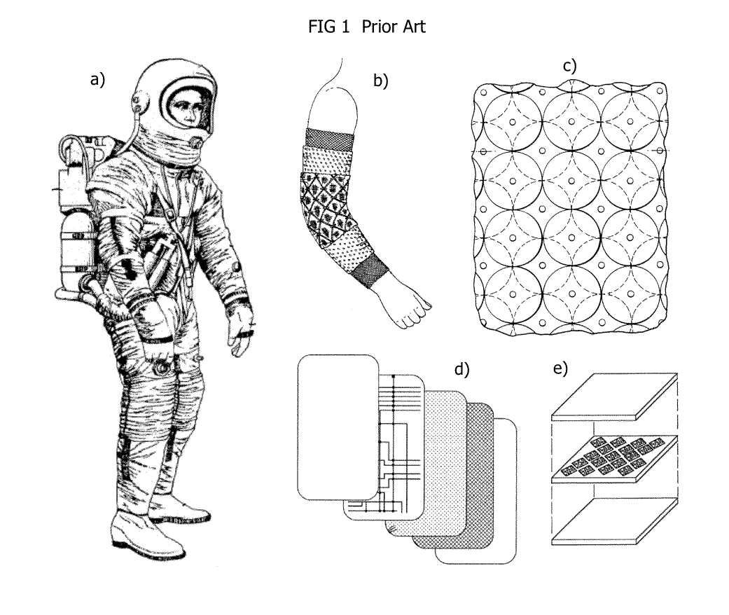

Three-dimensional pyramids are shown here as examples for constructing flexible skins made with flexible, bendable, semi-rigid, and rigid components. Other geometrical shapes such as cylinders, cubes, spheres, partial-spheres, and polygons in general may also be used but are not shown for the sake of brevity.

### DETAILED DESCRIPTION OF THE INVENTION

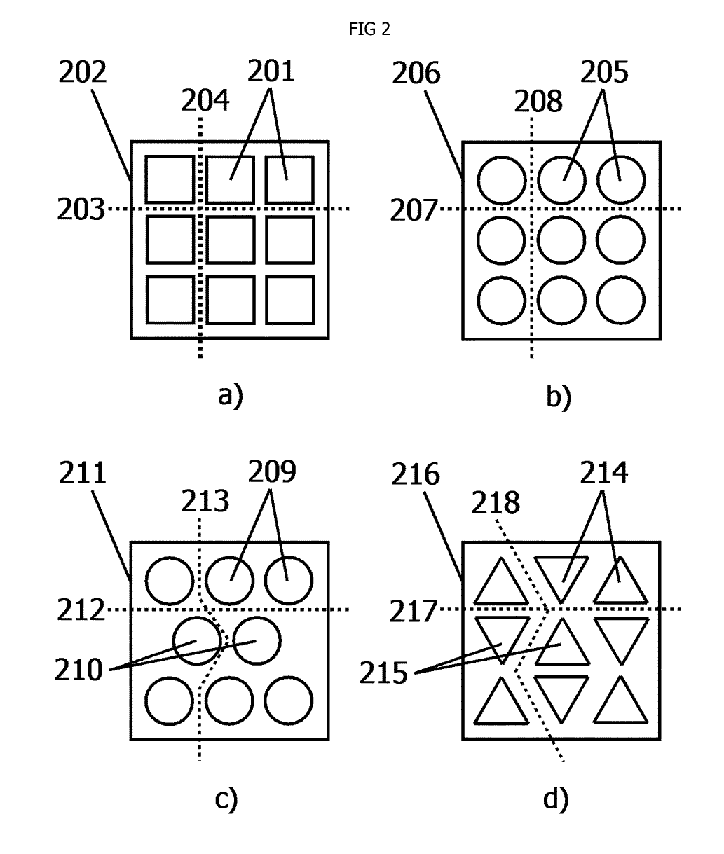

As a means of introduction to the subject of skins of flexible intelligence, FIG. 2(a) illustrates nine squares or rectangles 201 positioned on a flexible bendable sheet form 202. In the following description the words flexible and bendable may be interchanged for convenience. The squares 201 may be rigid, semi-rigid, or flexible and may be of the same material as the sheet form 201 which may also be rigid, semi-rigid, or flexible. For simplicity of initial explanation squares 201 are rigid and sheet form 202 is flexible. This allows for two preferential modes of flexing or bending along a horizontal axis 203 (indicated by a dotted line) or along a vertical axis 204 (indicated by a dotted line). If the arrangement of squares 201 and sheet form 202 is wrapped over a cylindrical curved three-dimensional surface it will tend to fold, bend, or flex about the two axes 203 and 204 and conform to the cylindrical surface. If the three-dimensional surface is of a compound curvature such as a sphere, then the arrangement of squares 201 and sheet form 202 will not completely conform to the surface. FIG. 2(b) illustrates a variation where the rigid squares or rectangles are substituted for rigid circles 205 on a flexible sheet form 206. In a similar fashion this arrangement will tend to fold along a horizontal axis 207 (indicated by a dotted line) or along a vertical axis 204 (indicated by a dotted line) and will not conform well to a compound curvature surface such as a sphere. FIG. 2(c) illustrates that by placing some of the circles 209 in a manner that is offset from other circles 210 across the sheet from 211 then the arrangement may be able to fold in more than two preferential directions, one along a horizontal axis 212 (indicated by a dotted line) and also along a multiple axis 213 (indicated by a dotted line). This arrangement shows improved ability to conform over a compound curvature surface such as a sphere compared to the arrangements of FIGS. 2(a) and 2(b). FIG. 2(d) illustrates circles replaced by triangles 214 in a manner that is offset from other triangles 215 across the sheet from 216. This arrangement may also fold in more than two preferential directions, one along a horizontal axis 217 (indicated by a dotted line) and also along the multiple axis 218 (indicated by a dotted line). This arrangement shows improved ability to conform over a compound curvature surface such as a sphere compared to the arrangements of FIGS. 2(a) and 2(b).

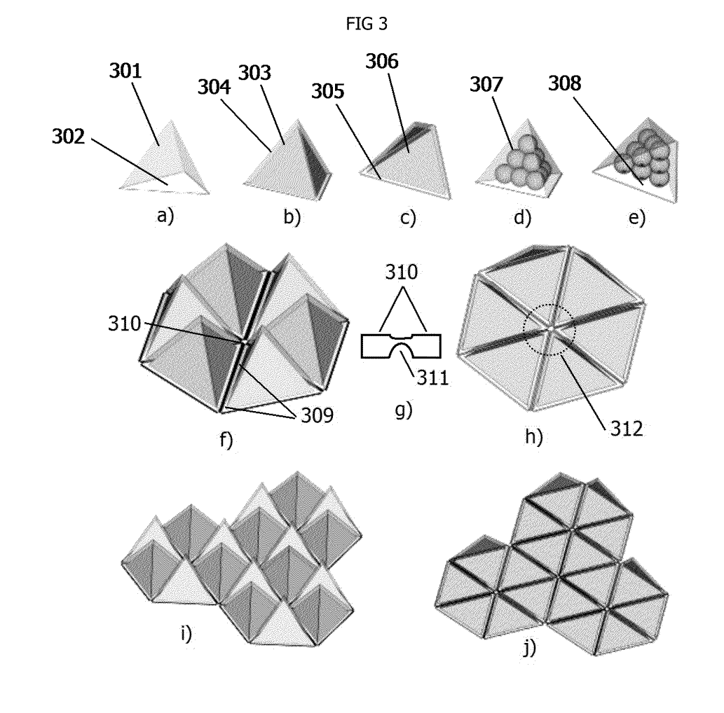

FIG. 3(a) shows an example of a four sided pyramid 301 constructed of an exemplary rigid wall material and a hollow interior cavity 302. The walls of the pyramid may also be constructed of a semi-rigid and/or flexible material to form a planar surface. FIG. 3(b) shows an example of a smaller four sided pyramid 303 within the cavity of a larger hollow pyramid 304. FIG. 3(c) shows the underside of the two pyramid arrangement of FIG. 3(b) where one side of the outer pyramid 305 has been removed to allow access to one side of the inner pyramid 306. FIG. 3(d) shows an example of a hollow pyramid filled with spherical structures 307. As an example, spheres containing colored dye may be used to indicate where a puncture in the surface of the pyramid has taken place if the spheres within are also punctured and release colored dye through the puncture hole of the pyramid surface. A further example may use adhesive components A and B, or an alternative chemical compound, within neighboring separate spheres that when punctured combine to form an adhesive mixture that seals the initial puncture. FIG. 3(e) shows the underside of the pyramid-sphere arrangement where one side of the pyramid 308 has been removed to allow access to the inner spheres. Design and manufacture of a hollow three sided pyramid allows its inner volume to be filled with arbitrary shapes at a later date. FIG. 3(f) shows an arrangement of six pyramids in a hexagon. Each pyramid has flexible joints along its base edges that are connected to each neighboring pyramid (one base edge join is indicated at 309) so that bending relative to each neighbor pyramid is possible and a small opening 310 at a central point may allow for increased bending capability. The bending joins may be constructed from a variety of materials such as bendable thin sheet films or elastic material. FIG. 3(g) illustrates a method for constructing a bendable join known as a ‘living hinge’ made of typically rigid materials but thin enough to bend repeatedly without breaking. Shown in cross-section each side of the hinge 310 has a central section 311 designed to allow bending and flexing around the central section. FIG. 3(h) shows the underside of the hexagonal pyramid arrangement of FIG. 3(f). A dotted circle 312 indicates where an elastic sheet form may be included in the arrangement to prevent solids, liquids, gases, or plasmas from passing through from the underside of the hexagonal structure to the top side or vice versa. The elastic sheet form may also be included on the top side of the hexagonal arrangement. FIG. 3(i) shows an example of a three hexagonal structure formed from pyramids used to extend over a larger surface area. Each hexagonal has six outer base edges that are connected with flexible joints to parts of a neighboring hexagonal structure's outer base edges. FIG. 3(j) shows the underside of the three hexagonal structure array of FIG. 3(i). It should be noted that FIG. 3 only illustrates pyramids that have a base equilateral triangle structure where each of the three base sides are equal in length. It is also possible and desirable to use pyramid structures that have a base isosceles triangle structure where two sides of the triangle are equal in length and the third side is unequal. It is also possible and desirable to use pyramid structures that have a base scalene triangle structure where all sides of the triangle are unequal in length. A mixture of equilateral, isosceles, and scalene triangle structures as pyramid bases is also possible and desirable.

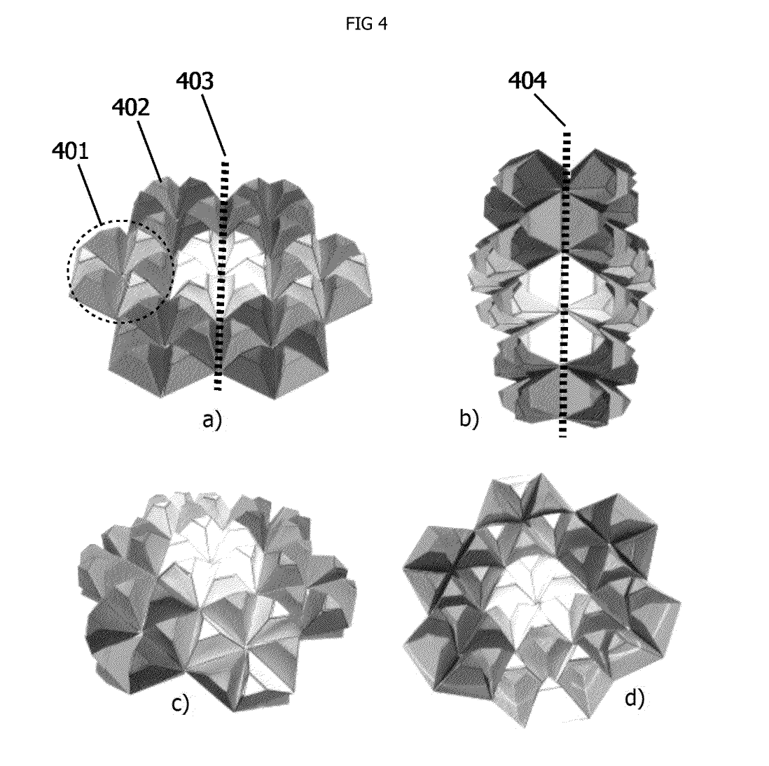

FIG. 4(a) shows an example of a single hexagon array 401 arranged with six neighboring hexagons on a flat surface. It also shows examples of pyramids that form a frustum, where each frustum includes a plateau top surface 402. It also indicates different shadings of gray scale for different pyramids within the arrangement that may provide different functions or capabilities within each pyramid. Dotted line 403 indicates one possible fold line for the arrangement of pyramids. FIG. 4(b) shows an example of the seven hexagon array folded along a multiple set of flexible joints 404 to allow conformal shape around a cylinder. FIG. 4(c) shows an example of the seven hexagon array folded along a multiple set of flexible joints to allow conformal shape around the outside of a sphere. FIG. 4(d) shows an example of the seven hexagon array folded along a multiple set of flexible joints to allow conformal shape around the inside of a sphere.

FIG. 5(a) shows a plan view of multiple hexagonal arrays of different sizes 501, 502, 503, and 504. The smaller dimension pyramids enable a tighter bending radius within their area of coverage. FIG. 5(b) shows an isometric view of the multiple hexagonal arrays of FIG. 5(a). FIG. 5(c) shows an alternative arrangement of small and large hexagons and pyramids.

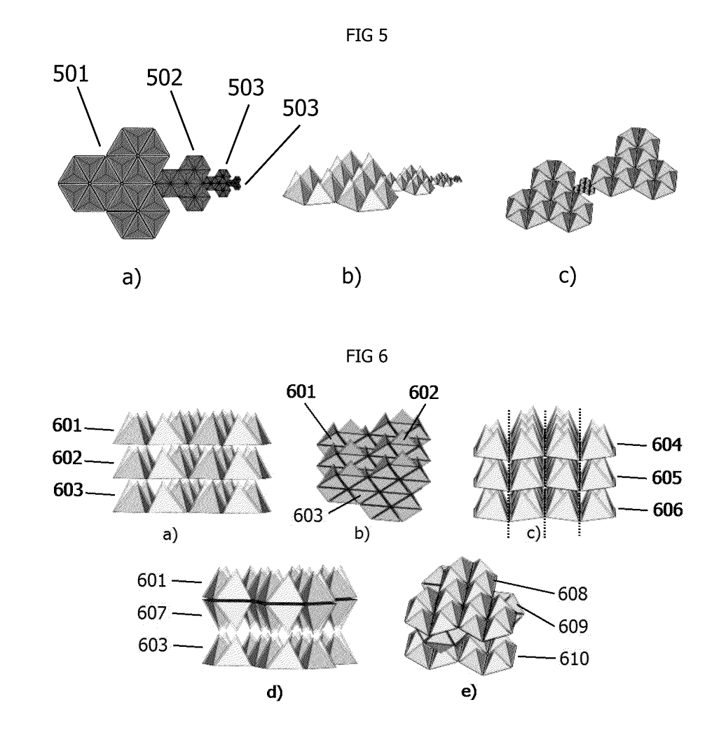

FIG. 6(a) shows an example of multiple layers of pyramids and hexagons 601, 602, and 603 in a side view. FIG. 6(b) shows the underside of the FIG. 6(a) arrangement in an isometric view. FIG. 6(c) shows an isometric view where the folding joints of each layer 604, 605, and 606 (indicated by dotted lines) can be seen in alignment. FIG. 6(d) shows an example of multiple layers of pyramids and hexagons in a side view where the middle layer 607 has been inverted. FIG. 6(e) shows an example of multiple layers of pyramids and hexagons where each successive layer 608, 609, and 610 has been rotated in relation to the layer below.

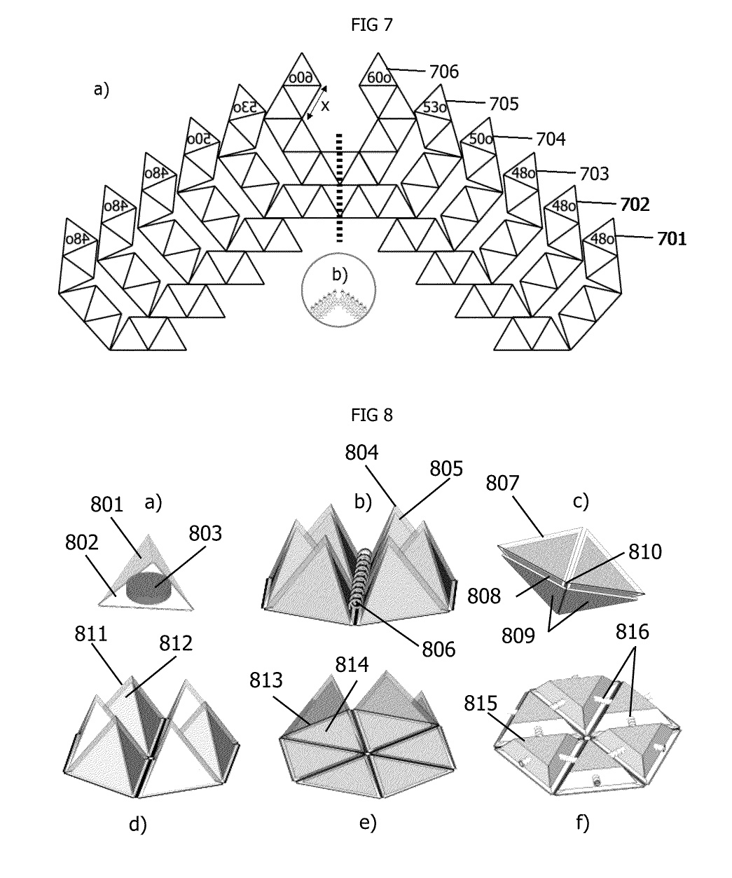

FIG. 7(a) shows an example of multiple layers of pyramids 701, 702, 703, 704, 705, and 706 of side length x bending around a central point indicated by a dotted line. In this example layer 701 bends at an angle of approximately 48 degrees, layer 702 bends at an angle of approximately 48 degrees, layer 703 bends at an angle of approximately 48 degrees, layer 704 bends at an angle of approximately 50 degrees, layer 705 bends at an angle of approximately 53 degrees, and layer 706 bends at an angle of approximately 60 degrees. For a value of x=2.5 mm, the inset picture of FIG. 7(b) shows that a bend radius of 25 mm can be obtained for the six layer structure.

FIG. 8(a) illustrates a four sided pyramid 801 with a fourth side 802 open with a disk part 803 within the volume or cavity of the pyramid. This part 803 may represent any type of device, for example but not limited to an electrical device, a magnetic device, an optical device, a thermal device, a chemical solid, liquid, gas, or plasma etc. FIG. 8(b) illustrates an example of how electrical wiring can be connected to an outer pyramid 804 or an inner pyramid 805. A coiled wire 806 allows for stretching, bending, or flexing as the pyramids bend or flex about each other. Multiple wires within a single coil allow for multiple electrical functions such as electrical power and ground supplies, and digital receive and digital transmit channels. Coiled wire may enter or exit the sides of the hollow pyramids 804 and/or 805 to gain access to the device within 803. FIG. 8(c) illustrates an example of an outer pyramid 807, an inner pyramid 808, and an artificial muscle 809 attached at the base of the pyramids across a flexible joint 810. By electrical connection, or other means, the artificial muscle may be caused to bend in one direction or another and subsequently the pyramids can be forced to move in a controlled direction. For a large skin connected with many muscle elements, control of the muscles may be achieved with a computer and multiplexed electrical signals to activate the muscles in a predetermined or responsive manner. As a consequence it may be possible to accentuate the muscle power of the suit wearer or arbitrarily manipulate the suit skin without a wearer inside. FIG. 8(d) illustrates an example of a hexagon structure comprised of six outer pyramids 811 and six internal pyramids 812 that serve as a container filled with a liquid, e.g., water. FIG. 8(e) illustrates the underside of the FIG. 8(d) arrangement where the outer pyramids 813 have an open side to allow the fluid filled inner pyramid container 814 to be accessible. FIG. 8(f) illustrates an example where each pyramid 815 upper side wall is connected to its nearest neighbor using a flexible tube or pipe 816. This allows the pyramids to continue bending relative to each other at the pyramid edge joints whilst allowing the tubes to flex as well. Tubes may allow transport of solids, liquids, gases, or plasmas from one pyramid neighbor to another.

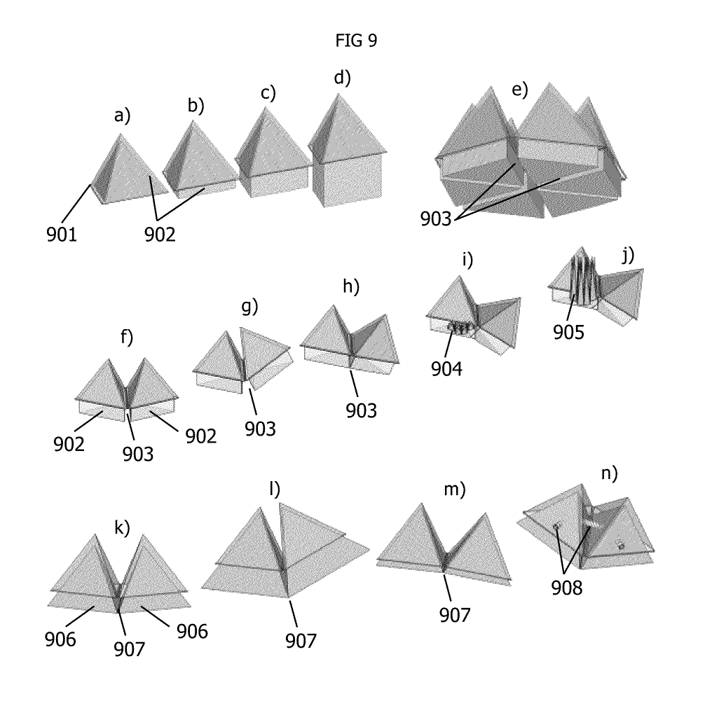

FIG. 9(a) illustrates an example of a hollow pyramid 901 with a gas filled inner pyramid container elastic balloon 902 at 1 atmosphere pressure (approximately 15 pounds per square inch). As the atmospheric pressure surrounding the two pyramid arrangement decreases, FIG. 9(b) illustrates that the inner elastic balloon 902 begins to expand so as to neutralize any pressure difference between the surrounding atmospheric pressure and the internal balloon pressure. FIG. 9(c) illustrates the inner elastic balloon expanding further and FIG. 9(d) illustrates where the inner elastic balloon gas pressure equals the surrounding atmospheric pressure and therefore expands no further. In this manner a suit of essentially rigid construction can be made to loosely fit a wearer of the suit when the external atmospheric pressure equals the pressure inside the inner elastic balloons. As the atmospheric pressure changes, for example decreases in comparison to the pressure inside the balloons, the inside of the suit will expand towards the skin of the wearer to provide a tight fit and be restricted from expanding further by the rigid arrangement of the outer pyramid structures. By thorough design, a suit may be constructed that by dropping the surrounding atmospheric pressure to zero, the pressure exerted by the internal balloons on the skin of the wearer is close to 1 atmosphere or approximately 15 pounds per square inch. FIG. 9(e) illustrates an example of a six pyramid hexagon arrangement with gas filled container balloons. It can be seen in this arrangement that there are gaps 903 between the edges of the expanded gas filled container balloons. FIG. 9(f) illustrates an example of the gap 903 between expanded gas container balloons 902 when the pyramids are on a flat surface. As the pyramid upper sides are bent towards each other, FIG. 9(g) illustrates the gap 903 between the gas balloons increasing. FIG. 9(h) illustrates an example of the pyramids upper sides bent away from each other and the gap 903 between the gas balloons can be decreased to zero. FIG. 9(i) illustrates an example where the pyramid upper sides are bent so far away from each other that the neighboring gas balloons now impinge on each other and would require an additional external force to compress the displaced gas. To allow for tighter bend radii without additional external force then smaller side length pyramids 904 may be used as also shown in FIG. 9(i). To compensate for the smaller gas volume inside the smaller pyramids of FIG. 9(i), the height of the smaller pyramids may be extended 905 as shown in FIG. 9(j). FIG. 9(k) shows an alternate example of the gap 907 between expanded gas balloons 906 when the pyramids are on a flat surface. In this case the gas balloons may expand so that there is no gap between their edges. As the pyramid upper sides are bent towards each other, FIG. 9(l) shows the gas balloons volume increasing to keep the gap 907 between the balloon edges at zero. FIG. 9(m) shows an example of the pyramids upper sides bent away from each other where the gas balloons volume decrease to keep the gap 907 between the balloon edges at zero. This would require an additional external force to compress the displaced gas. FIG. 9(n) shows a method of connecting the gas balloons via neighboring tubes 908 so that compressed gas in one pyramid may escape to a connected pyramid to reduce the force required for gas compression when bending. If an individual gas balloon that is not connected via tubes to any neighboring gas balloon is punctured then only the punctured balloon will deflate and no longer apply the original pressure on the skin of the wearer. This gives a suit constructed of many individual gas balloons a redundancy feature to maintain overall pressure against the entire skin except in the region where an individual gas balloon has been punctured. This mechanism also applies to individual gas balloons that may be connected via tubes to a limited number of other gas balloons. If one of the gas balloons in the limited group is punctured then only those gas balloons connected to the limited group will deflate. As an example, this mechanism may be used to protect astronauts in the event that their suit is punctured in the vacuum of space. In contemporary space suit designs that use large inflatable bladders to encompass large portions or all of the suit wearers body, one puncture in the suit skin can deflate the entire suit resulting in extreme loss of pressure that is life threatening. This redundancy feature can also be applied to pyramid containers filled with liquids, solids, or plasmas. Interconnecting tubes may also feed valves constructed inside the pyramid containers that restrict the flow of fluids.

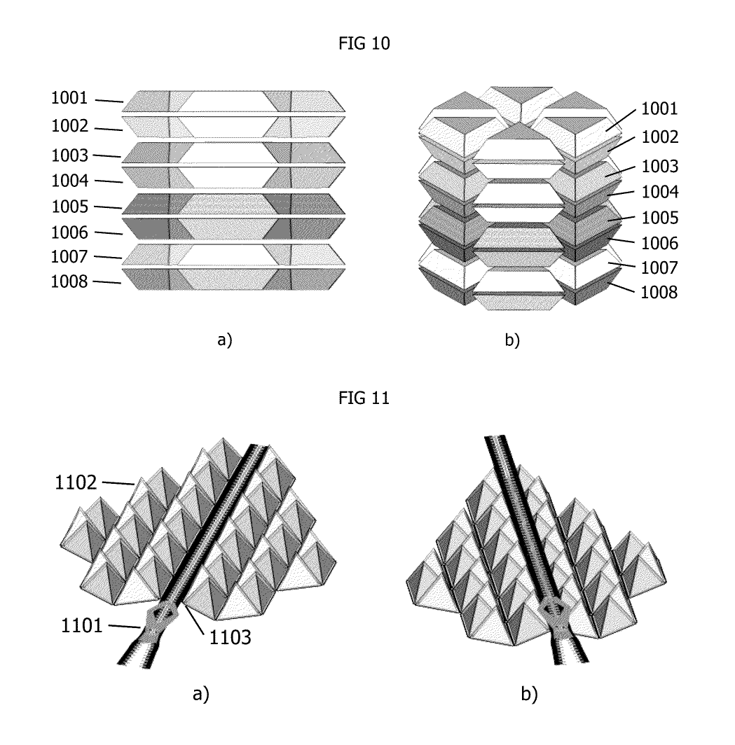

FIG. 10(a) shows an example of eight layers of pyramids 1001, 1002, 1003, 1004, 1005, 1006, 1007, and 1008 stacked on top of each other. Each layer may provide different functions such as a pressure garment, a cooling garment, a thermal barrier layer, or an armored layer etc. Multiple functions may exist within a layer, for example, cooling pyramids may be distributed throughout a pressure garment layer 1008 by substituting individual gas balloon pyramids for water filled pyramids. A medical sensor patch such as those used for ECG heart measurements could be attached to the expanding base of a gas balloon in layer 1008 nearest to the skin of the wearer to provide a non-adhesive electrode held in place by the pressure balloon above it and around it. FIG. 10(b) shows an isometric view of the eight layer structure. Pyramids with frustum plateau top shapes may provide for reduced physical interference between layers as the multi-layer structure is bent around a curve compared to pyramids with pointed tops.

FIG. 11(a) illustrates an example of a zipper mechanism 1101 integrated with a pyramid structure 1102. In this case the zipper lies on the same plane as the base of the pyramids 1103. FIG. 11(b) shows an example of a zipper mechanism integrated with the pyramid structure at a height above the base of the pyramids. In this case pyramid bases can extend below the zipper plane. For compression garments this allows expanding gas balloons to extend to all areas of the skin beneath the zipper. Attachment of the zipper sides to a frustum plateau top pyramid shape may increase the mating strength of the zipper sides to the plateau top (not shown).

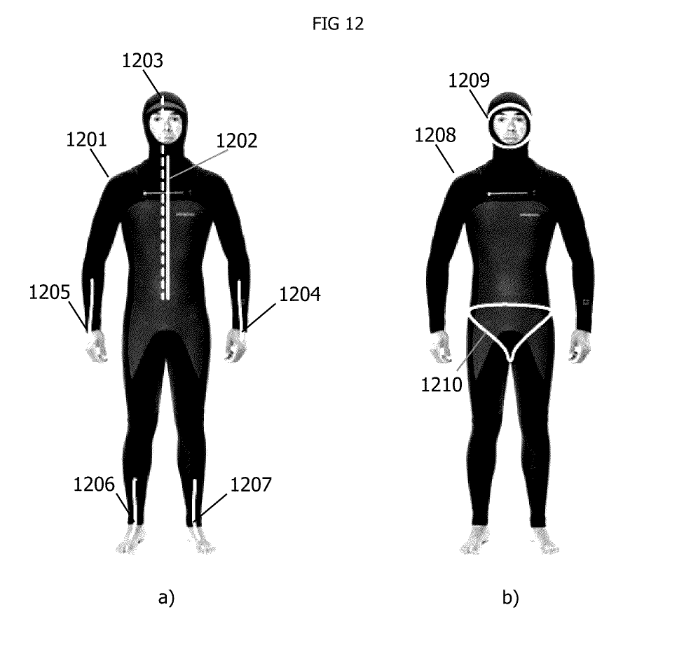

FIG. 12(a) illustrates an example of zipper positions that allow an artificial skin 1201 to be designed that covers the human body and can be donned and doffed by entering and exiting the main torso zipper position 1202 (shown as a vertical white line). A dotted white line represents a zipper 1203 fitted to the back instead of the front that may be more conducive to frontal bending of the torso. Zippers located near the hands and wrists 1204 and 1205 may also provide for ease of donning and doffing (gloves are not shown here but may also be part of the suit). Zippers located near the feet and ankles 1206 and 1207 may also provide for ease of donning and doffing (boots are not shown here but may also be part of the suit). FIG. 12(b) illustrates an example of a suit 1208 where pyramid based compression garments may be less effective. These are the orifice areas of nose, mouth, eyes, and ears 1209 (indicated by a white line), and crotch regions 1210 (indicated by a white line). These regions may require a gas filled area with inflated air tight bladder seals around the outlined edges.

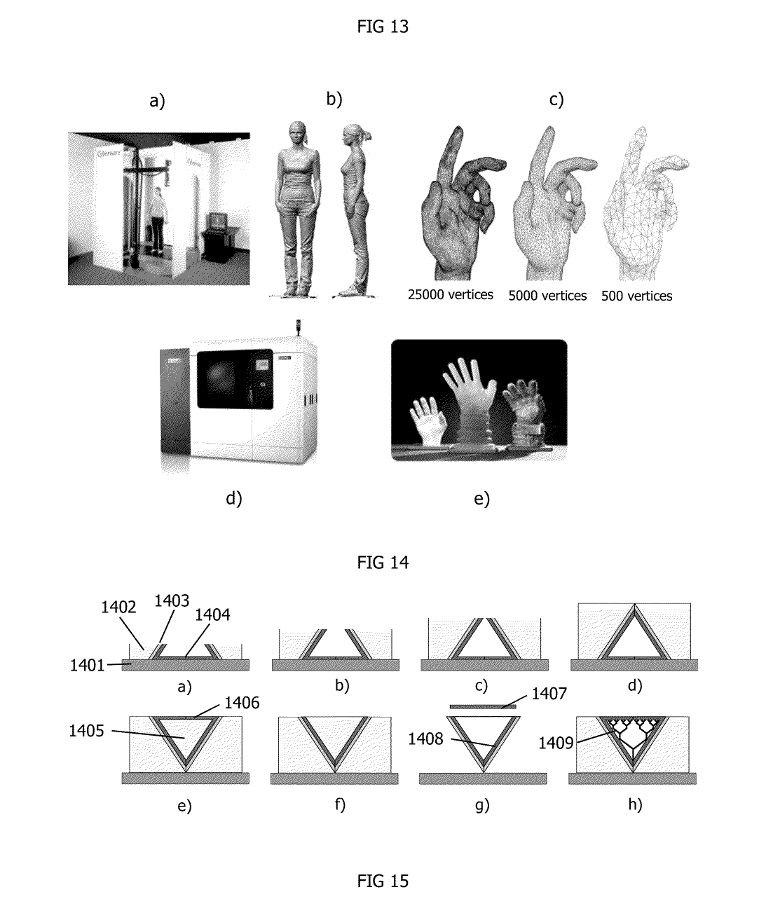

FIG. 13(a) shows an example of a three-dimensional body scanner. This can be used to accurately measure the contours of any individual shape. FIG. 13(b) shows an example of the scanned computer model to represent the shape. FIG. 13(c) illustrates an example of how a body part can be subdivided into polygons of different sizes. Software that automatically divides the scanned body patterns into triangles of different sizes provides for a customized pyramid design to any individual shape. FIG. 13(d) shows an example of a rapid prototyping machine where computer designed models may be fabricated layer by layer using materials of different hardness or elasticity and other mechanical properties. FIG. 13(e) shows an example of parts grown in rapid prototype machines.

FIG. 14 illustrates an example of how structures are grown inside rapid prototyping machines, layer by layer. FIG. 14(a) shows a base table 1401, build material 1402, hollow outer pyramid material 1403, and inner pyramid material 1404. As each layer is built up, as shown in FIGS. 14(b), 14(c), and 14(d), the overhanging internal structure is at a low enough angle from the vertical that the pyramid can be completed without any build materials inside. FIG. 14(e) shows that this cannot be achieved with an inverted grown pyramid. Build material 1405 must be laid down inside the pyramid to allow the flat top of the inner pyramid 1406 to be supported and fabricated. Once the top is fabricated, there is no means to remove the build material inside. FIG. 14(f) shows an example of an inverted pyramid built without a flat top. FIG. 14(g) shows the inverted pyramid with the build material washed away such that a flat top 1407 may be attached to the inner pyramid 1408 outside of the prototype machine. FIG. 14(h) shows an example of an inner tree structure 1409 inside the inner pyramid that supports the deposition of the flat top without the need for solid build material filling the pyramid. The tree structure is grown layer by layer along with the other structures.

FIG. 15(a) illustrates an example of a pre-fabricated hollow outer pyramid 1501 having a smaller pre-fabricated inner pyramid 1502 inserted into it. FIG. 15(b) illustrates the final structure. FIG. 15(c) illustrates an example of a pre-fabricated inner pyramid constructed with a metal base layer 1503 that may act as an armor shield. Using two or more layers of armor shield can provide improved impact protection, c.f., Whipple shields. A Whipple shield uses multiple layers of thin sheet material, usually metal, to reduce the catastrophic impact effects of high momentum particles and are commonly used to protect the outer hulls of spacecraft. When a high momentum particle impacts the first layer of sheet material, it punctures through and is split into many smaller particles of lower individual momentum. These particles may partially puncture a second layer of sheet material and split further into even smaller particles of lower individual momentum. The momentum of each individual particle may be so reduced that impact at any further sheet materials is not sufficient to puncture them.

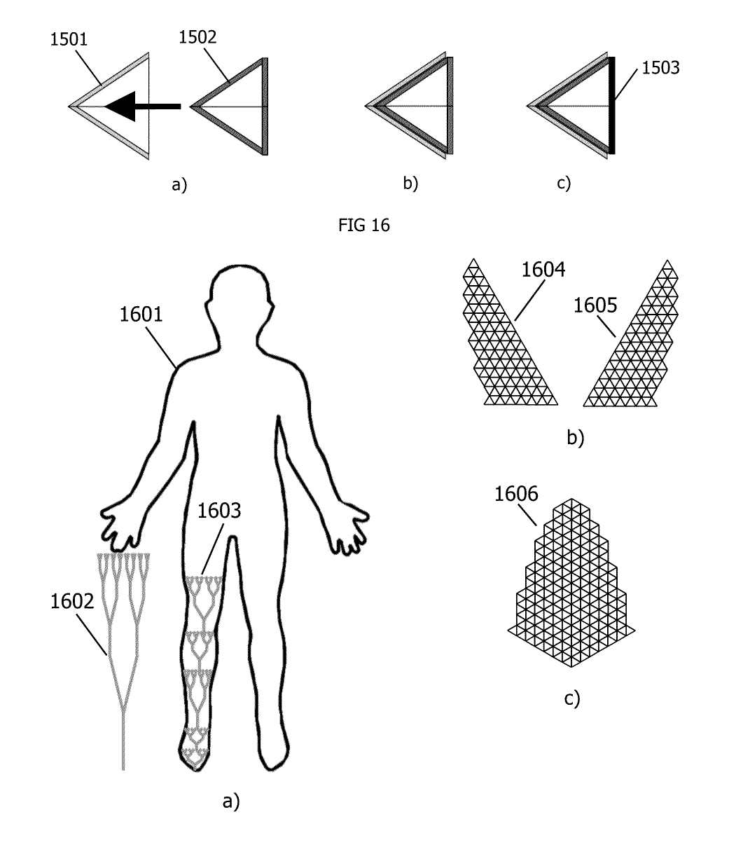

FIG. 16(a) illustrates an example of a pyramid skin for a human shape 1601 built inside a rapid prototype machine. To reduce the amount of build materials needed to support the skin, and to reduce the amount of build material to be later removed, a tree structure support mechanism 1602 (on the outside of the human shape) and 1603 (on the inside of the human shape) may be used to support the skin as it is grown layer by layer. FIG. 16(b) illustrates that portions of the three dimensional skin may also be fabricated as flat sections 1604 and 1605 and subsequently joined together to form a single skin 1606 illustrated in FIG. 16(c). This method of construction may be more suitable to more contemporary methods of machining or cast molding where surface areas typically larger than rapid prototype machines can be fabricated. These contemporary methods also allow a greater selection of available construction materials at the current time.

By way of example we now briefly describe the operation of an astronaut space suit constructed using a skin of flexible intelligence or articulated artificial skin. The suit is donned with the aid of zippers as previously described. Internal pressurization of the suit against the human skin can be achieved by a mixture of increasing the pressure of the internal gas balloons and by lowering the surrounding environmental pressure (zero for the vacuum of space). A breathing air mixture or pure oxygen is supplied to the oro-nasal area through a network of integrated gas tubes and exhaled gas is removed through a similar network of tubes. Exhaled gas can be scrubbed of carbon dioxide by passing through a network of scrubber solid materials distributed in the cavities and containers of the suit skin layers. Similarly it may be possible to have the air/oxygen supply stored in miniature pressurized gas tanks inside the cavities and containers of the suit skin layers and distributed over the suit skin and this may promote a more convenient center of gravity for the suit wearer. Apollo mission astronauts routinely fell over due their high center of gravity caused by the large bulky Primary Life Support System (PLSS) worn as a backpack. Cool water is circulated through a network of integrated tubes to multiple water cavities and containers in the artificial skin layer to remove (or add) heat from the wearer and removed using a similar network of tubes to have heat radiated away. Instead of a large bulk radiator housed in the PLSS, smaller radiators may be positioned within cavities and containers of the suit skin and distributed over the body. Motion of the astronaut is less restricted and can be amplified using artificial muscle. Lighting of the surrounding environment can be provided through LEDs and battery power embedded within the cavities and containers over the suit with recharging power available through distributed solar panels within the cavities and containers. Levels of high energy radiation can be detected and monitored within the cavities and containers and protection from micro-meteoroid impact is provided by Whipple shield layers within the cavities and containers. Any impact sites may be indicated through the release of dye capsules from the within the cavities and containers of the suit skin and repaired automatically through the release of adhesives embedded within the cavities and containers of the skin. Communications equipment can be positioned around the face area within the suit skin itself.

1. An articulated artificial skin comprising:
a layer of material comprising a plurality of pyramids formed of a rigid, semi-rigid, or flexible material, wherein each one of the plurality of pyramids comprises a base edge, and wherein the base edge of each one of the plurality of pyramids is flexibly coupled to the base edge of a different one of the plurality of pyramids.

2. The articulated artificial skin of claim 1, further comprising:
a cavity within one of the plurality of pyramids wherein the cavity comprises a container of solid material;

3. The articulated artificial skin of claim 1, further comprising:
a cavity within one of the plurality of pyramids wherein the cavity comprises a container of liquid material;

4. The articulated artificial skin of claim 1, further comprising:
a cavity within one of the plurality of pyramids wherein the cavity comprises a container of gaseous material;

5. The articulated artificial skin of claim 1, further comprising:
a cavity within one of the plurality of pyramids wherein the cavity comprises a container of plasma material;

6. The articulated artificial skin of claim 1, further comprising:
a cavity within one of the plurality of pyramids wherein the cavity comprises an electronic circuit;

7. The articulated artificial skin of claim 1, further comprising:
a cavity within one of the plurality of pyramids wherein the cavity comprises a battery;

8. An articulated artificial skin of claim 1, further comprising a hexagon, wherein the hexagon comprises:
a set of six pyramids, wherein each one of the set of six pyramids comprises:
a first base edge, wherein the first base edge is flexibly coupled to a first neighboring one of the set of six pyramids; and
a second base edge, wherein the second base edge is flexibly coupled to a second neighboring one of the set of six pyramids;
an opening at a center point of the hexagon.

9. An articulated artificial skin of claim 8, wherein each one of the plurality of hexagons comprises an outer base edge, and wherein one or more of the outer base edges of one of the plurality of hexagons is flexibly coupled to an outer edge of a neighboring one of the plurality of hexagons.

10. An articulated artificial skin of claim 8 wherein the hexagon further comprises an elastic sheet covering the opening.

11. An articulated artificial skin of claim 1 wherein at least one of the pyramids forms a frustum comprising a plateau top surface.

12. The articulated artificial skin of claim 1 wherein the layer of material is a first layer, and wherein the articulated artificial skin further comprises:
a second layer of material comprising:
a second plurality of pyramids formed of a rigid, semi-rigid, or flexible material, wherein each one of the second plurality of pyramids comprises a base edge, and wherein the base edge of each one of the second plurality of pyramids is flexibly coupled to the base edge of a different one of the second plurality of pyramids.

13. The articulated artificial skin of claim 1, further comprising:
a layer of material comprising:
a first plurality of pyramids formed of a rigid, semi-rigid, or flexible material, wherein each one of the first plurality of pyramids comprises a base edge having a first base edge length, and wherein the base edge of each one of the first plurality of pyramids is flexibly coupled to the base edge of a different one of the first plurality of pyramids;
and
a second plurality of pyramids formed of a rigid, semi-rigid, or flexible material, wherein each one of the second plurality of pyramids comprises a base edge having a second base edge length, and wherein the base edge of each one of the second plurality of pyramids is flexibly coupled to the base edge of a different one of the second plurality of pyramids;
wherein the second plurality of pyramids is flexibly coupled to the first plurality of pyramids, and wherein the second base length is smaller than the first base length.

14. The articulated artificial skin of claim 1, further comprising:
an electrical network, wherein the electrical network electrically connects neighboring pyramids.

15. The articulated artificial skin of claim 1, further comprising:
an artificial muscle, wherein the artificial muscle flexibly couples a first one of the plurality of pyramids to a second one of the plurality of pyramids.

16. The articulated artificial skin of claim 1, further comprising:
a means to fluidly connect neighboring pyramids using transporting tubes and pipes.

17. The articulated artificial skin of claims 1, further comprising a plurality of pressure balloons arranged in a fifth array wherein each of the plurality of pressure balloons is contained with one of the plurality of pyramids.

18. The articulated artificial skin of claim 1, further comprising:
a zipper, wherein the zipper couples a first set of the plurality of pyramids to a second set of the plurality of pyramids.

19. The articulated artificial skin of claim 1, further comprising:
a fifth plurality of cavities within the pyramid first array that may contain a variety of technologies such as but not limited to batteries, electronic components, integrated circuits, small circuit boards, light emitting diodes, lasers, photo-receptors, electro-magnets, thermo-electric coolers, microphones, audio speakers, wireless transceivers, solar panels, accelerometers, thermometers, barometers, altimeters, radiation detectors, chemical detectors, adhesives, dyes, phase-change materials, metals, chemical compounds, etc.

20. The articulated artificial skin of claim 1, further comprising:
an inner tree structure inside one of the plurality of pyramids.
